(19) United States
(12) Patent Application Publication
(10) Pub. No.: US 2004/0190689 A1
(43) Pub. Date: Sep. 30, 2004

(54) Telecommunication system providing independent user selection of media type for reception and/or transmission

(76) Inventors: Mariana Benitez Pelaez, Naperville, IL (US); Anne Yin-Fee Lee, Naperville, IL (US); Stinson Samuel Mathai, Wheaton, IL (US); Randall J. Wilson, Naperville, IL (US)

Correspondence Address: Richard J. Minnich, Fay, Sharpe, Fagan, Minnich & McKee, LLP, Seventh Floor, 1100 Superior Avenue, Cleveland, OH, 44114, US

(21) Appl. No.: 10/403,164

(22) Filed: Mar. 31, 2003

(51) Int. Cl. H04M 11/00

(52) U.S. Cl. 379/88.13; 379/88.14

(57) ABSTRACT

A method of converting between media types in a call session conducted over a multimedia communications network (10) includes receiving call set-up signaling from a calling party. The call set-up signaling initiates establishment of the call session and identifies the calling party's selection of a first media type which the calling party desires to use for participation in the call session. The method further includes inviting a called party to join the call session, querying the called party to determine the called party's selection of a second media type which the called party desires to use for participation in the call session, and receiving a response to the query, the response identifying the called party's selection of the second media type. A bearer path is then established between the calling party and the called party over the multimedia communications network (10), and communications exchanged by the calling and called parties via the bearer path are converted between the first and second media types in accordance with the respective selections of each party.

### FIELD

The present invention relates to the art of telecommunications. It finds particular application in conjunction with multimedia communication devices utilizing a public data network (PDN), such as a packet switched data network, and will be described with particular reference thereto. However, it is to be appreciated that the present invention is also amenable to other like applications and suited to other similar communication networks or environments.

### BACKGROUND

Many end user communications devices in the telecommunications field, commonly known as user equipment, terminals, user agents, etc., are equipped to handle multiple types of communication media, such a device shall be referred to herein as a multimedia terminal (MMT). Conversely, a terminal which is equipped to handle only one type of media shall be referred to herein as a single media terminal (SMT), e.g., an ordinary telephone equipped to handle only voice communications, or a simple pager equipped to handle only text messages.

Regarding MMTs, wireless or mobile telephones, for example, are known which accommodate voice communications as well as text communications. Other known mobile MMTs include wireless enabled personal digital assistants, wireless enabled notebook or laptop computers, etc. Additionally, line-based MMTs are also known, such as, suitably equipped general purpose computers (e.g., desktops).

The text communications supported by many MMTs include, short message service, instant and/or text messaging, etc. Packet switched data networks (PSDN), e.g., the Internet and the like, have been developed to manage and/or route these text communications between MMTs. These networks have also been adapted to manage and/or route packetized voice communications as well, e.g., via Voice Over Internet Protocol (VOIP) telephony.

In certain instances, a user of a MMT may find it desirable to select the type of media used for incoming and outgoing communications during a call session. Heretofore, a calling party could opt to use a desired media type, be it voice or text, when initiating a call session. For example, when desiring to make a voice call, the calling party simply places the voice call using the MMT's voice mode in the usual manner, or alternately, when desiring to communicate via text, the calling party simply sends the text message using the MMT's text mode in the usual manner. However, the called party is typically unable to select their media type of choice. That is to say, the called party is forced to accept the media choice of the calling party, which may not be the media type desired by the called party. Additionally, for both the calling and called party, the media type selected typically could not be different for incoming and outgoing communications received and transmitted, respectively, by their MMT. For example, should a voice call be placed by the calling party, then the calling party is limited to voice media for both outgoing and incoming communications for that call session, the called party also being so limited. Likewise, should a text message be sent by the calling party, then the calling party is limited to text media for both outgoing and incoming communications for that call session, the called party again being similarly limited. There remained, therefore, a desire to have more freedom in media selection by users of MMTs.

The present invention contemplates a new and improved telecommunications method and/or system which overcomes the above-referenced problems and others.

### SUMMARY

In accordance with an aspect of the present invention, a method of converting between media types in a call session conducted over a multimedia communications network is provided. The method includes: receiving call set-up signaling from a calling party, the call set-up signaling initiating establishment of the call session and identifying the calling party's selection of a first media type which the calling party desires to use for participation in the call session; inviting a called party to join the call session; querying the called party to determine the called party's selection of a second media type which the called party desires to use for participation in the call session; receiving a response to the query, the response identifying the called party's selection of the second media type; establishing a bearer path between the calling party and the called party over the multimedia communications network; and, converting communications exchanged by the calling and called parties via the bearer path between the first and second media types in accordance with the respective selections of each party.

In accordance with another aspect of the present invention, a system for converting between media types in a call session conducted over a multimedia communications network includes: means for receiving call set-up signaling from a calling party, the call set-up signaling initiating establishment of the call session and identifying the calling party's selection of a first media type which the calling party desires to use for participation in the call session; means for inviting a called party to join the call session; means for querying the called party to determine the called party's selection of a second media type which the called party desires to use for participation in the call session; means for receiving a response to the query, the response identifying the called party's selection of the second media type; means for establishing a bearer path between the calling party and the called party over the multimedia communications network; and, means for converting communications exchanged by the calling and called parties via the bearer path between the first and second media types in accordance with the respective selections of each party.

In accordance with yet another aspect of the present invention, an Internet protocol multimedia subsystem (IMS) for managing call sessions within a telecommunications network includes: at least one of a media gateway (MGW) and a multimedia resource function processor (MRFP) through which a bearer path is defined to establish to a call session conducted over the IMS between a first terminal and a second terminal; a call session control function (CSCF) which regulates operation of the IMS, the CSCF providing functional control the MGW and MRFP and receiving for at least one of the first and second terminals signaling indicative of a media type selected by a user of the terminal, the indicated media type being the user's media of choice for participation in the call session; and, a text-to-speech/speech-to-text (T-S/S-T) converter which converts between text and speech media types, said converter, under the direction of the CSCF, being selectively employed, in accordance with the user's media of choice, to convert media exchanged between the first and second terminals over the bearer path defining the call session.

One advantage of the present invention is the ability to provide for media selection by a receiving party independently of the media selection made by the transmitting party.

Another advantage of the present invention is the ability to provide for independent user selection of reception and transmission media types in the same call session, the reception and transmission media types optionally being distinct from one another.

Still further advantages and benefits of the present invention will become apparent to those of ordinary skill in the art upon reading and understanding the present specification.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention. Further, it is to be appreciated that the drawings are not to scale.

FIG. 1 is a diagrammatic illustration showing an exemplary telecommunications environment suitable for practicing aspects of the present invention.

FIG. 2 is a flow chart illustrating a call session management process and/or method with independent user media selection in accordance with aspect of the present invention.

### DETAILED DESCRIPTION OF PREFERRED EMBODIMENTS

For simplicity and ease of reference, the following acronyms shall be used in the present specification to refer to structural and/or functional network elements and/or entities, relevant telecommunications standards, protocols and/or services, terminology, etc., as they are commonly known in the telecommunications art, except to the extent they have been modified in accordance with aspects of the present invention:

3G—3^{rd} Generation

3GPP—3^{rd} Generation Partnership Project

3GPP2—3^{rd} Generation Partnership Project 2

AAA—Authentication/Authorization/Accounting

AH—Address Handling

AS—Application Server

BGCF—Border Gateway Control Function

CCF—Call Control Function

CDMA—Code Division Multiple Access

CSCF—Call Session Control Function

HLR—Home Location Register

HSS—Home Subscriber Server

ICGW—Incoming Call Gateway

IMS—IP Multimedia Subsystem

IP—Internet Protocol

MGCF—Media Gateway Control Function

MGW—Media Gateway

MMT—Multimedia Terminal

MRFC—Multimedia Resource Function Controller

MRFP—Multimedia Resource Function Processor

PDN—Public Data Network

PLMN—Public Land Mobile Network

PSDN—Packet Switched Data Network

PSTN—Public Switched Telephone Network

RAN—Radio Access Network

SIP—Session Initiation Protocol

SMS—Short Message Service

SMT—Single Media Terminal

SPD—Serving Profile Database

T-S/S-T—Text to Speech/Speech to Text

UMTS—Universal Mobile Telecommunications System

VOIP—Voice over IP

WLAN—Wireless Local Area Network

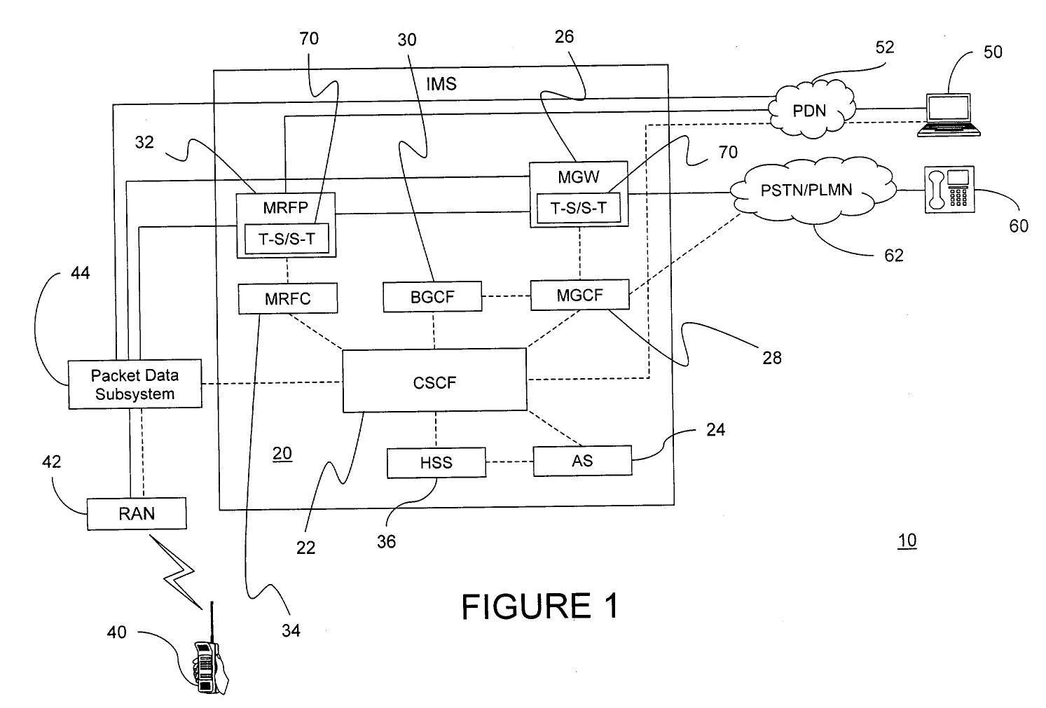

With reference to FIG. 1, an optionally 3GPP/3GPP2 compliant telecommunications environment or network 10 is equipped and/or arranged to manage and/or route multimedia communications between terminals employing the same. Other suitable telecommunications environments, however, may be employed. The network 10 includes an IMS 20 that incorporates in the usual manner a number of network entities and/or elements, namely, one or more of a CSCF 22, AS 24, MGW 26, MGCF 28, BGCF 30, MRFP 32, MRFC 34, HSS 36. As is known in the art, the IMS 20 manages call sessions and provides and administers packet switching for multimedia communications (e.g., text messages, packetized voice communications, etc.) within the network 10.

For exemplary purposes, an MMT 40 (nominally the first terminal) is shown as a mobile MMT (namely, a multimedia enabled mobile phone as is commonly known) that is operatively connected to the IMS 20 via a RAN 42. The RAN 42, as it is known, is that portion of a mobile network that handles subscriber access, including radio base stations and control and concentration nodes, i.e., the portion relating to “over the air” communications between the mobile terminal and the network base station. A packet data subsystem 44 interfaces the RAN 42 with the IMS 20 and the PDN 52 in the usual manner.

Another MMT 50 (nominally the second terminal) is shown as a laptop or notebook type computer operatively connected to the IMS 20 via a PDN 52. The MMT 50 optionally employs a WLAN or wire line, in the usual manner, to operatively connect to the PDN.

An SMT 60 (nominally the third terminal) is shown as an ordinary telephone equipped to handle only voice communications. The SMT 60 is operatively connected to the IMS 20 via a PSTN/PLMN 62.

Only a single first, second and third terminal are shown in FIG. 1 for the purpose of simplicity herein. However, it is to be appreciated that typically a plurality of such terminals are similarly situated. Additionally, while depicted as a specific type of MMT or SMT, other like terminals are also contemplated.

With continuing reference to FIG. 1, the bearer paths, as are known in the art, that carry and/or relay the communication traffic and/or user information intended to be transmitted from one terminal to another are shown as solid lines. Control paths, as are known in the art, carry and/or relay associated signaling and/or control commands or messages to and between appropriate network elements and/or entities such that call sessions are properly managed and routed. The control paths are shown as dashed lines in FIG. 1. Suitably, SIP and/or other appropriate known protocols are used on the control and bearer paths, respectively, e.g., the known H.248 protocol is suitably employed for media gateway controls. The CSCF 22, BGCF 30, MGCF 28, MRFC 34 and AS 24 comprise the call control and signaling functionality for the IMS 20, while the bearer paths interface with the MRFP 32 and MGW 26 to provide and support interconnectivity to external networks and/or subsystems, such as, the packet data subsystem 44, PDN 52 and PSTN/PLMN 62.

The CSCF 22 supports and controls multimedia sessions. The CSCF 22 invites the MGCF 28 and/or MRFC 34 to call sessions to control the establishment and maintenance of bearer paths for call sessions, e.g., by adding, modifying or deleting appropriate bearer paths for respective call sessions. The CSCF 22 is the signaling entity for call session control. It manages sessions (e.g., using SIP and/or other appropriate call/session establishment protocols), provides features and services and coordinates with other network elements for session control, service control and resource allocation. The functions performed by the CSCF 22 are Incoming Call Gateway (ICGW), Call Control Function (CCF), Serving Profile Database (SPD) and Address Handling (AH).

The ICGW function acts as a call session entry point and routes incoming calls.

The CCF executes call setup/termination and state/event management. It interacts with the MGCF 28 for calls to/from the PSTN/PLMN 62, and with the BGCF 30 for calls to the PSTN/PLMN 62 to determine the appropriate MGCF 28 to use. It also controls the MRFP 32 via the MRFC 34 (which interprets information or signals coming from the CSCF 22 and controls the MFRP 32 accordingly) in order to support conferencing and other multi-party services. SIP level registrations from subscribers are processed in CCF. The CCF may provide service trigger mechanisms to the AS 24 to invoke services provided thereby (either locally, at the AS 24, or elsewhere). It also reports call events for billing, auditing, intercept or other purposes, and may query the AH function to check whether a requested outgoing communication is allowed given the current subscription.

The SPD function interacts with the HSS 36 to receive and cache user profile information, and the AH function performs address handling, including address analysis, translation, modification (when appropriate) and mapping.

The MGW 26 acts as a bearer path interface between the IMS 20 and externals networks and/or subsystems, and provides translation resources and resources for modifying the bearer stream (e.g., encoding, transcoding, compression, packetization, depacketization, etc.). It interacts with the MGCF 28 (which interprets signaling coming from the CSCF 22 and controls the MGW 26 accordingly) in order to achieve resource allocation, bearer path control, and payload processing. The MGCF 28 communicates with the CSCF 22 in order to control the call state for media channels on one or more MGWs and performs conversions between legacy and 3G UMTS/CDMA network call control protocols. Similarly, the MRFC 34 controls the media stream resources in the MRFP 32 which also acts as a bearer path interface between the IMS 20 and external networks and/or subsystems, however, being able to provide for conferencing or multiple party communications or other more advanced media services (relative to the MGW 26).

The HSS 36 maintains subscriber and system related data, user profiles, locations, etc. Optionally, the HSS 36 also contains what is known as the HLR functionality and/or AAA function. Suitably, the HSS database includes: user identification, via numbering and addressing information; user security information, including network access control information for authentication and authorization; user location information for user registration and locating; and a user profile, including identification of the services subscribed to and other service specific information.

With continuing reference to FIG. 1, in accordance with aspects of the present invention, one or more T-S/S-T converters 70 are incorporated in the otherwise conventional IMS 20. The T-S/S-T converter 70 selectively converts text into speech and/or speech into text. That is to say, it receives input text media being transported along a bearer path and outputs into the bearer path stream corresponding voice media, and vice versa.

Suitably, as shown, the T-S/S-T converters 70 are incorporated as an available resource in the MGW 26 for two party call sessions and the MRFP 32 for conference call sessions, and may be of any appropriate type known in the art. While for the purposes of simplicity and clarity herein the following discussion only refers expressly to an exemplary two party call session, it is to be appreciated that it can similarly be extended and/or applied to conference call sessions.

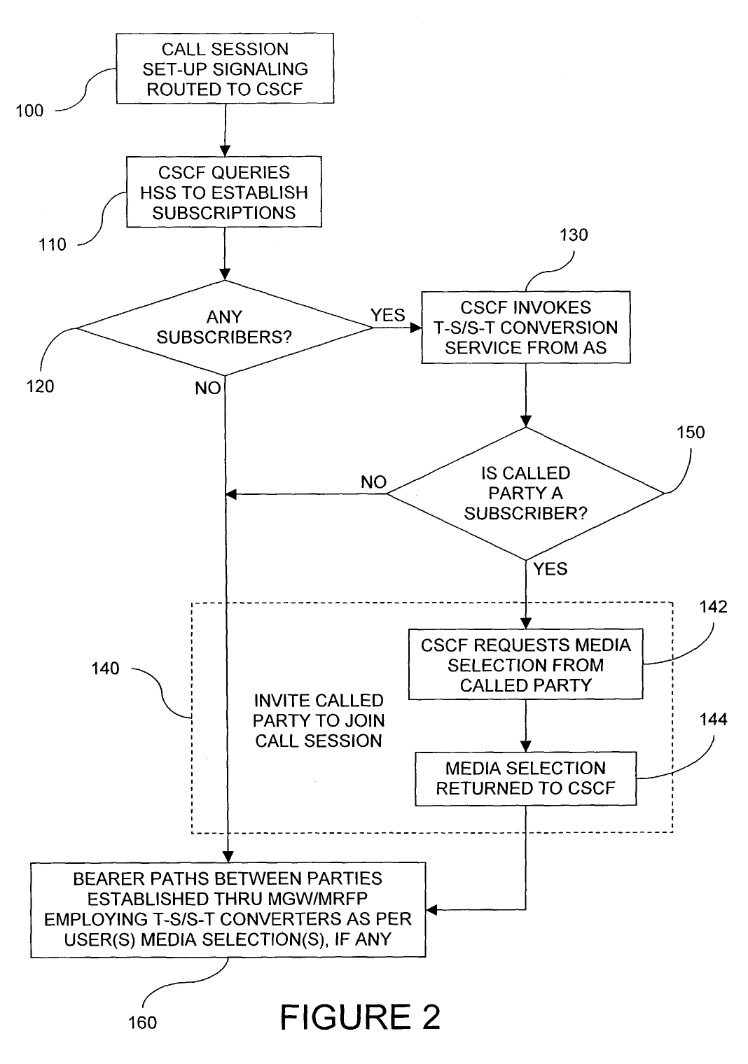

With reference now to FIG. 2 and continuing reference to FIG. 1, a call session carried out over the IMS 20 in accordance with aspects of the present invention is described by way of example. Without loss of generality, in the present example, the first terminal 40 shall be considered the calling party (user A) and the called party (user B) shall be considered generally as the second terminal 50 (or alternately, for certain exemplary purposes, the third terminal 60).

The call session begins at a call set-up step 100 when user A initiates a call session with the MMT 40 whereupon suitable call set-up signaling is transmitted to the CSCF 22 for establishing a call session with the MMT 50 over the IMS 20. Optionally, when initiating the call session, user A selectively designates via the MMT 40 their choice of media type to be used during the call session for transmission, reception or both. Notably, the media type may or may not be the same for both transmission and reception. Suitably, the media type user A selects to initiate the call session is the default media choice for transmission, and optionally also for reception. In any event, the MMT 40 sends appropriate signaling to the CSCF 22, along with the other call set-up signaling, indicative of user A's media selections for transmission, reception or both.

Upon receipt of the call-set up signaling, the CSCF 22 queries the HSS 36 at step 110 to check and/or establish user A's identity, access rights and/or other like details as is customary. In addition, user A's profile maintained at the HSS 36 is checked to confirm and/or establish that they subscribe to a T-S/S-T media conversion service. Additionally, the called party's profile (i.e., user B's profile) is similarly checked to confirm and/or establish that they subscribe to the T-S/S-T media conversion service.

As determined in decision step 120, if one or both parties subscribe to the T-S/S-T media conversion service, then at step 130 the CSCF 22 invokes the T-S/S-T media conversion service from the AS 24 that provides functional controls for the converter 70. Otherwise, the flow proceeds to an invite step 140 where the called party (user B) is invited to join the call session in the usual manner, e.g., such that the MMT 50 or SMT 60, as the case may be, produces a designated incoming communication alert.

As determined in decision step 150, if the called party (user B) subscribes to the T-S/S-T media conversion service, then sub-steps 142 and 144 are carried out in conjunction with the other processes performed in the invite step 140, otherwise the invite step 140 is conducted without the sub-steps. In sub-step 142, the CSCF 22 sends query signaling to the appropriate terminal, i.e., the MMT 50 or SMT 60, as the case may be, to obtain user B's choice of media for transmission, reception or both. Again, notably, the media type may or may not be the same for both transmission and reception. Optionally, absent an affirmative selection by user B, the default media types are selected to correspond to those of user A (i.e., user B's reception media would be the same as user A's transmission media, and user B's transmission media would be the same as user A's reception media), or, absent a selection to the contrary, the transmission media for user B may default to user B's reception media selection.

At sub-step 144, appropriate signaling is returned to the CSCF 22 indicative of user B's designation of media types to be used in the call session at their terminal (i.e., the MMT 50 or SMT 60, as the case may be) for transmission, reception or both. In the case of the user B employing the MMT 50, the return signaling originates from the MMT 50 upon user B entering their selections therein or otherwise default selections being may thereby. However, in the case of the SMT 60 being the called party, the are no media choices to be made being that only a single media type is supported by the terminal. Accordingly, the return signaling optionally originates elsewhere. For example, when the terminal 60 is a standard voice only telephone, intelligence from the PSTN/PLMN 62 may recognize the same and return signaling indicative thereof to the CSCF 22.

After the relevant call session details have been negotiated, the call session is established at step 150. That is to say, under the appropriate controls, a suitable bearer path is established between the parties through the MGW 26 and/or the MRFP 32 employing the respective T-S/S-T converts 70 in accordance with the users' choices of media types for transmission and/or reception, if any. Optionally, if the calling party (user A) has not otherwise designated a media type for reception of incoming traffic, the reception media type for user A defaults to the transmission media type chosen by user B. Additionally, where calling party's terminal does not support the called party's chosen transmission media type, the T-S/S-T converter 70 is automatically implemented to provide the appropriate conversion.

Suitably, once the call session has been established, either user may opt to alter their chosen media type for transmission or reception or both, for example, by selective operation of their terminal to provide signaling of the desired change to the CSCF 22, which in turn reacts accordingly (i.e., interacting with the AS 24, MGCF 28 and/or MRFC 34 to regulate implementation of the converts 70 in the MGW 26 and/or MRFP 32, respectively, through which the bearer path for the call session passes). Optionally, upon detecting a transmission from one party being of a media type not correspond to the selected reception media type of the other party, the receiving party's terminal is prompted (via appropriate signaling from the CSCF 22) with the option to change their reception media type selection.

To further appreciate the operation and/or capabilities of the IMS 20 equipped with the T-S/S-T converter(s) 70, consider the following exemplary scenario wherein both user A (the calling party) and user B (the called party) are subscribers to the T-S/S-T conversion service. User B is in a meeting and receives an incoming voice call from user A. User B will get the option to receive the call in a voice or text mode. If user B answers the call via a voice mode the call will proceed as it does normally. However, if user B opts to receives the call in a text mode so as not to disrupt the meeting with an audible conversation, the IMS 20 employing one or more of its converters 70 will convert the user A's speech into text that will then be transmitted to user's B terminal.

The called party (user B) is able to respond in via text media and the IMS 20 in turn optionally queries the calling party (user A) to determine whether they wishes to continue the call in a voice or text mode. If user A wishes to continue in a voice mode, then the user B's typed text is converted in the IMS 20 from text to speech via one or more of its converters 70. Of course, this can be expanded to many combinations. For example, the calling party (user A) may wish to continue to talk or voice outgoing communications, but given that the called party (user B) is responding with text media, the calling party (user A) may wish to receive the actual response text instead of receiving the speech converted from text. Accordingly, when queried, user A would not opt to continue reception in the voice mode but rather opt to change to text media for reception.

Notably, the media conversion functionality provided by the T-S/S-T converters 70 has the advantage of reducing bandwidth and quality of service demands since real time voice is no longer being transmitted over the air wherever text is sent instead of voice. While such converts may be employed in at the terminals, placing the T-S/S-T converter 70 in the IMS 20 provides greater flexibility and the opportunity for the implementation of better and more powerful conversion algorithms due to the increased resource capacity available at the IMS 20 relative to the terminals. Suitably, the T-S/S-T conversion is optimized for each subscriber by storing their speech information in their user profile maintained on the HSS 36. The speech information optionally includes information related to the subscriber's slang, native language and/or dialect, etc.

It is to be appreciated that in connection with the particular exemplary embodiments presented herein certain structural and/or function features are described as being incorporated in and/or with defined elements and/or components. However, it is contemplated that these features may, to the same or similar benefit, also likewise be incorporated in and/or with other elements and/or components and/or in other various embodiments where appropriate. It is also to be appreciated that different aspects of exemplary embodiments may be selectively mixed and matched as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the invention has been described with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of converting between media types in a call session conducted over a multimedia communications network, said method comprising:
(a) receiving call set-up signaling from a calling party, said call set-up signaling initiating establishment of the call session and identifying the calling party's selection of a first media type which the calling party desires to use for participation in the call session;
(b) inviting a called party to join the call session;
(c) querying the called party to determine the called party's selection of a second media type which the called party desires to use for participation in the call session;
(d) receiving a response to the query, said response identifying the called party's selection of the second media type;
(e) establishing a bearer path between the calling party and the called party over the multimedia communications network; and,
(f) converting communications exchanged by the calling and called parties via the bearer path between the first and second media types in accordance with the respective selections of each party.

2. The method of claim 1, further comprising:
determining if at least one of the calling party and the called party subscribe to a media conversion service whereby the method is provided thereto.

3. The method of claim 2, further comprising:
invoking the media conversion service when it is determined that at least one of the calling party and the called party subscribe to the media conversion service, otherwise not invoking the media conversion service.

4. The method of claim 1, wherein one of the first and second media types is text and the other is speech.

5. The method of claim 1, wherein the call set-up signaling also identifies the calling party's selection of a third media type which the calling party desires to use for participation in the call session, the first media type being used for transmission of outgoing communications from the calling party and the third media type being used for reception of incoming communications by the calling party.

6. The method of claim 5, wherein one of the first and third media types is text and the other is speech.

7. The method of claim 1, further comprising:
querying the called party to determine the called party's selection of a third media type which the called party desires to use for participation in the call session; and,
receiving a response to the query, said response identifying the called party's selection of the third media type, the second media type being used for transmission of outgoing communications from the called party and the third media type being used for reception of incoming communications by the called party.

8. The method of claim 7, wherein one of the second and third media types is text and the other is speech.

9. A system for converting between media types in a call session conducted over a multimedia communications network, said system comprising:
means for receiving call set-up signaling from a calling party, said call set-up signaling initiating establishment of the call session and identifying the calling party's selection of a first media type which the calling party desires to use for participation in the call session;
means for inviting a called party to join the call session;
means for querying the called party to determine the called party's selection of a second media type which the called party desires to use for participation in the call session;
means for receiving a response to the query, said response identifying the called party's selection of the second media type;
means for establishing a bearer path between the calling party and the called party over the multimedia communications network; and,
means for converting communications exchanged by the calling and called parties via the bearer path between the first and second media types in accordance with the respective selections of each party.

10. The system of claim 9, further comprising:
means for determining if at least one of the calling party and the called party subscribe to a media conversion service whereby the method is provided thereto.

11. The system of claim 10, further comprising:
means for invoking the media conversion service when it is determined that at least one of the calling party and the called party subscribe to the media conversion service, otherwise not invoking the media conversion service.

12. The system of claim 9, wherein one of the first and second media types is text and the other is speech.

13. The system of claim 9, wherein the call set-up signaling also identifies the calling party's selection of a third media type which the calling party desires to use for participation in the call session, the first media type being used for transmission of outgoing communications from the calling party and the third media type being used for reception of incoming communications by the calling party.

14. The method of claim 13, wherein one of the first and third media types is text and the other is speech.

15. The system of claim 9, further comprising:
means for querying the called party to determine the called party's selection of a third media type which the called party desires to use for participation in the call session; and,
means for receiving a response to the query, said response identifying the called party's selection of the third media type, the second media type being used for transmission of outgoing communications from the called party and the third media type being used for reception of incoming communications by the called party.

16. The method of claim 15, wherein one of the second and third media types is text and the other is speech.

17. An Internet protocol multimedia subsystem (IMS) for managing call sessions within a telecommunications network comprising:
at least one of a media gateway (MGW) and a multimedia resource function processor (MRFP) through which a bearer path is defined to establish to a call session conducted over the IMS between a first terminal and a second terminal;
a call session control function (CSCF) which regulates operation of the IMS, said CSCF providing functional control the MGW and MRFP and receiving for at least one of the first and second terminals signaling indicative of a media type selected by a user of the terminal, said indicated media type being the user's media of choice for participation in the call session; and,
a text-to-speech/speech-to-text (T-S/S-T) converter which converts between text and speech media types, said converter, under the direction of the CSCF, being selectively employed, in accordance with the user's media of choice, to convert media exchanged between the first and second terminals over the bearer path defining the call session.

18. The IMS of claim 17, further comprising:
a home subscriber server (HSS), said HSS maintaining subscriber information and being access by the CSCF to identify if the user subscribes to a T-S/S-T conversion service, such that subscribers to the T-S/S-T conversion service are entitled to implement the T-S/S-T converter during the call session and non-subscribers are not.

19. The IMS of claim 17, wherein the T-S/S-T converter is incorporated in at least one of the MWG and the MRFP.
